(19) United States
(12) Patent Application Publication
(10) Pub. No.: US 2023/0291504 A1
(43) Pub. Date: Sep. 14, 2023

(54) METHOD AND USER EQUIPMENT FOR CONSTRUCTING HARQ-ACK CODEBOOK

(71) Applicant: FG Innovation Company Limited, Tuen Mun (HK)

(72) Inventors: CHIEN-CHUN CHENG, Taipei (TW); CHIA-HAO YU, Taipei (TW); HSIN-HSI TSAI, Taipei (TW)

(21) Appl. No.: 17/796,040

(22) PCT Filed: Apr. 29, 2021
(86) PCT No.: PCT/CN2021/091064

§ 371 Date: Jul. 28, 2022

Related U.S. Application Data
(60) Provisional application No. 63/018,469, filed on Apr. 30, 2020.

(51) Int. Cl. H04L 1/18; H04W 76/20; H04W 74/08

(52) U.S. Cl. CPC H04L 1/1812; H04W 74/0841; H04W 76/20; H04W 84/06

(57) ABSTRACT

A method, performed by a User Equipment (UE) for constructing a Hybrid-Automatic-Repeat-Request Acknowledge (HARQ-ACK) codebook, includes receiving a Radio Resource Control (RRC) message from a Network (NW), the RRC message including an indication to the UE whether to disable a HARQ feedback for a HARQ process; if the indication of the RRC message indicates to the UE to disable the HARQ feedback for the HARQ process, not generating a HARQ-ACK bit corresponding to a first Transport Block (TB) and generating at least one HARQ-ACK bit corresponding to at least one second TB; and if a Downlink Control Information (DCI) format from the NW indicates to the UE to feedback reception of the first TB and the at least one second TB in a same slot, multiplexing the at least one HARQ-ACK bit to construct the HARQ-ACK codebook for the first TB and the at least one second TB.

### CROSS REFERENCE TO RELATED APPLICATION(S

This application is the National Stage, filed under 35 U.S.C. § 371, of International Patent Application No. PCT/CN2021/091064, filed on Apr. 29, 2021, which claims the benefit of and priority to U.S. Provisional Pat. Application Serial No. 63/018,469, filed on Apr. 30, 2020. The contents of all above-named applications are hereby fully incorporated herein by reference for all purposes.

### FIELD

The present disclosure is generally related to wireless communications and, more specifically, to a method and a user equipment for constructing a Hybrid-Automatic-Repeat-Request Acknowledge (HARQ-ACK) codebook.

### BACKGROUND

With the tremendous growth in the number of connected devices and the rapid increase in user/Network (NW) traffic volume, various efforts have been made to improve different aspects of wireless communication for next-generation wireless communication systems, such as the fifth-generation (5G) New Radio (NR) system, by improving data rate, latency, reliability, and mobility.

The 5G NR system is designed to provide flexibility and configurability to optimize NW services and types, accommodating various use cases such as Enhanced Mobile Broadband (eMBB), Massive Machine-Type Communication (mMTC), and Ultra-Reliable and Low-Latency Communication (URLLC).

However, as the demand for radio access continues to increase, there is a need in the art to improve generating/constructing the Hybrid-Automatic-Repeat-Request Acknowledge (HARQ-ACK) codebook.

### SUMMARY

The present disclosure is directed to methods and user equipment (UE) for constructing a Hybrid-Automatic-Repeat-Request Acknowledge (HARQ-ACK) codebook.

According to an aspect of the present disclosure, a method performed by a User Equipment (UE) for constructing a Hybrid-Automatic-Repeat-Request Acknowledge (HARQ-ACK) codebook is provided. The method includes receiving a Radio Resource Control (RRC) message from a Network (NW), the RRC message including an indication to disable a HARQ feedback for a HARQ process; if the indication of the RRC message indicates to the UE to disable the HARQ feedback for the HARQ process, not generating a HARQ-ACK bit corresponding to a first Transport Block (TB) and generating at least one HARQ-ACK bit corresponding to at least one second TB; and if a Downlink Control Information (DCI) format from the NW indicates to the UE to feedback reception of the first TB and the at least one second TB in a same slot, multiplexing the at least one HARQ-ACK bit to construct the HARQ-ACK codebook for the first TB and the at least one second TB.

According to another aspect of the present disclosure, a User Equipment (UE) in a wireless communication system for constructing a Hybrid-Automatic-Repeat-Request Acknowledge (HARQ-ACK) codebook is provided. The UE includes a processor; and a memory coupled to the processor, wherein the memory stores a computer-executable program that, when executed by the processor, causes the UE to receive a Radio Resource Control (RRC) message from a Network (NW), the RRC message including an indication to disable a HARQ feedback for a HARQ process; if the indication of the RRC message indicates to the UE to disable the HARQ feedback for the HARQ process, not generate a HARQ-ACK bit corresponding to a first Transport Block (TB) and generate at least one HARQ-ACK bit corresponding to at least one second TB; and if a Downlink Control Information (DCI) message from the NW indicates to the UE to feedback reception of the first TB and the at least one second TB in a same slot, multiplexing the at least one HARQ-ACK bit to construct the HARQ-ACK codebook for the first TB and the at least one second TB.

### BRIEF DESCRIPTION OF THE DRAWINGS

Aspects of the present disclosure are best understood from the following when read with the accompanying figures. Various features are not drawn to scale. Dimensions of various features may be arbitrarily increased or reduced for clarity of discussion.

FIG. 1 is a system diagram illustrating an overview of a non-terrestrial network (NTN) according to an example implementation of the present disclosure.

FIG. 2 is a time/frequency diagram illustrating a scenario of three different bandwidth parts (BWPs) being configured according to an example implementation of the present disclosure.

FIG. 3 is a timing diagram illustrating Physical Downlink Shared Channel (PDSCH) receptions with an active downlink (DL) BWP change via a DCI format according to an example implementation of the present disclosure.

FIG. 4 is a timing diagram illustrating Semi-Persistent Scheduling (SPS) PDSCH reception with an active DL BWP change via a DCI format according to an implementation of the present disclosure.

FIG. 5 is a diagram illustrating a Type-2 HARQ-ACK codebook with more than T_{D}=4 missed DCI formats according to an implementation of the present disclosure.

FIG. 6 is a flowchart illustrating a procedure for HARQ-ACK codebook construction performed by a UE according to an implementation of the present disclosure.

FIG. 7 is a block diagram illustrating a node for wireless communication according to an implementation of the present disclosure.

### DESCRIPTION

At least some of the acronyms in the present disclosure are defined as follows. Unless otherwise specified, the acronyms have the following meanings.

| | |
|---|---|
| Acronym | Full name |
| 3GPP | 3^{rd} Generation Partnership Project |
| BS | Base Station |
| BWP | Bandwidth Part |
| CBG | Code Block Group |
| C-RNTI | Cell Radio Network Temporary Identifier |
| CSI | Channel State Information |
| DAI | Downlink Assignment Indicator |
| DCI | Downlink Control Information |
| DL | Downlink |
| DL-SCH | Downlink-Shared Channel |
| EFB | Earth Fixed Beam |
| EMB | Earth Moving Beam |
| FDD | Frequency-Division Duplex |
| gNB | Base Station |
| GNSS | Global Navigation Satellite System |
| HO | Handover |
| HARQ | Hybrid Automatic Repeat Request |
| ID | Identification |
| LEO | Low Earth Orbiting |
| LTE | Long Term Evolution |
| MAC | Medium Access Control |
| MSGB-RNTI | Message B-Radio Network Temporary Identifier |
| MCG | Master Cell Group |
| NACK/ACK | Non-Acknowledgment/Acknowledgment |
| NR | New Radio |
| NTN | Non-Terrestrial Network(s) |
| NW | Network |
| OFDM | Orthogonal Frequency Division Multiplexing |
| PCell | Primary Cell |
| PDCCH | Physical Downlink Control Channel |
| PDSCH | Physical Downlink Shared Channel |
| PRB | Physical Resource Block |
| PUCCH | Physical Uplink Control Channel |
| PUSCH | Physical Uplink Shared Channel |
| RA | Random Access |
| RACH | Random Access Channel |
| RAN | Radio Access Network |
| Rel | Release |
| RNTI | Radio Network Temporary Identifier |
| RRC | Radio Resource Control |
| SCell | Secondary Cell |
| SCG | Secondary Cell Group |
| SpCell | Special Cell |
| SPS | Semi-Persistent Scheduling |
| SRS | Sounding Reference Signal |
| SUL | Supplementary Uplink |
| TA | Timing Advance |
| TB | Transport Block |
| T-CRNTI | Temporary Cell Radio Network Temporary Identifier |
| TDD | Time-Division Duplex |
| TRP | Transmission/Reception Point |
| TR | Technical Report |
| TS | Technical Specification |
| UE | User Equipment |
| UL | Uplink |
| UL-SCH | Uplink Shared Channel |
| WI | Working Item |

The following contains specific information pertaining to implementations of the present disclosure. The drawings and their accompanying detailed disclosure are directed to merely exemplary implementations. However, the present disclosure is not limited to these exemplary implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For consistency and ease of understanding, like features are identified (although, in some examples, not illustrated) by numerals in the example figures. However, the features in different implementations may differ in other respects, and thus shall not be narrowly confined to what is illustrated in the figures.

References to “one implementation,” “an implementation,” “example implementation,” “various implementations,” “some implementations,” “implementations of the present disclosure,” etc., may indicate that the implementation(s) of the present disclosure may include a particular feature, structure, or characteristic, but not every possible implementation of the present disclosure necessarily includes the particular feature, structure, or characteristic. Further, repeated use of the phrase “in one implementation,” “in an example implementation,” or “an implementation,” do not necessarily refer to the same implementation, although they may. Moreover, any use of phrases like “implementations” in connection with “the present disclosure” are not meant to characterize that all implementations of the present disclosure must include the particular feature, structure, or characteristic, and should instead be understood to mean “at least some implementations of the present disclosure” include the stated particular feature, structure, or characteristic.

The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-disclosed combination, group, series, and the equivalent.

The term “and/or” is only an association relationship for describing associated objects, and represents that three relationships may exist, for example, A and/or B may represent that: A exists alone, A and B exist at the same time, and B exists alone. “A and/or B and/or C” may represent that at least one of A, B and C exists. In addition, the character “/” generally represents that the former and latter associated objects are in an “or” relationship.

Additionally, for the purpose of non-limiting explanation, specific details, such as functional entities, techniques, protocols, standards, and the like, are set forth for providing an understanding of the disclosed technology. In other examples, a detailed disclosure of well-known methods, technologies, systems, architectures, and the like are omitted in order not to obscure the present disclosure with unnecessary details.

Persons skilled in the art will immediately recognize that any NW function(s) or algorithm(s) in the present disclosure may be implemented by hardware, software, or a combination of software and hardware. Disclosed functions may correspond to modules that may be software, hardware, firmware, or any combination thereof. The software implementation may comprise computer-executable instructions stored on computer-readable media such as memory or other types of storage devices.

For example, one or more microprocessors or general-purpose computers with communication processing capability may be programmed with corresponding executable instructions and carry out the disclosed NW function(s) or algorithm(s). The microprocessors or general-purpose computers may be formed of Application-Specific Integrated Circuits (ASICs), programmable logic arrays, and/or using one or more Digital Signal Processor (DSPs). Although some of the example implementations in the present disclosure are directed to software installed and executing on computer hardware, alternative example implementations implemented as firmware, hardware, or a combination of hardware and software are well within the scope of the present disclosure.

The computer-readable medium includes but is not limited to Random Access Memory (RAM), Read-Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication NW architecture (e.g., a LTE system, an LTE-Advanced (LTE-A) system, or an LTE-Advanced Pro system) typically includes at least one BS, at least one UE, and one or more optional NW elements that provide connection towards an NW. The UE communicates with the NW (e.g., a Core Network (CN), an Evolved Packet Core (EPC) NW, an Evolved Universal Terrestrial Radio Access NW (E-UTRAN), a Next-Generation Core (NGC), a 5G Core Network (5GC), or an Internet), through a RAN established by the BS.

It should be noted that, in the present disclosure, a UE may include, but is not limited to, a mobile station, a mobile terminal or device, a user communication radio terminal. For example, a UE may be a portable radio equipment, which includes, but is not limited to, a mobile phone, a tablet, a wearable device, a sensor, or a Personal Digital Assistant (PDA) with wireless communication capability. The UE is configured to receive and transmit signals over an air interface to one or more cells in a RAN.

A BS may include, but not limited to, a Node B (NB) as in the Universal Mobile Telecommunication System (UMTS), an evolved Node B (eNB) as in the LTE-A, a Radio NW Controller (RNC) as in the UMTS, a Base Station Controller (BSC) as in the Global System for Mobile communications (GSM)/GSM EDGE Radio Access NW (GERAN), a Next Generation eNB (ng-eNB) as in an E-UTRA BS in connection with the 5GC, a gNB as in the 5G Access NW (5G-AN), and any other apparatus capable of controlling radio communication and managing radio resources within a cell. The BS may connect to serve the one or more UEs through a radio interface to the NW.

A BS may be configured to provide communication services according to at least one of the following Radio Access Technologies (RATs): Worldwide Interoperability for Microwave Access (WiMAX), GSM (often referred to as 2G), GERAN, General Packet Radio Service (GPRS), UMTS (often referred to as 3G) based on basic Wideband-Code Division Multiple Access (W-CDMA), High-Speed Packet Access (HSPA), LTE, LTE-A, enhanced LTE (eLTE), NR (often referred to as 5G), and LTE-A Pro. However, the scope of the present disclosure should not be limited to the protocols previously disclosed.

The BS may be operable to provide radio coverage to a specific geographical area using a plurality of cells included in the RAN. The BS may support the operations of the cells. Each cell is operable to provide services to at least one UE within its radio coverage. More specifically, each cell (often referred to as a serving cell) may provide services to serve one or more UEs within its radio coverage, (e.g., each cell schedules the DL and optionally UL resources to at least one UE within its radio coverage for DL and optionally UL packet transmissions). The BS may communicate with one or more UEs in the radio communication system through the plurality of cells. A cell may allocate sidelink (SL) resources for supporting proximity service (ProSe). Each cell may have overlapped coverage areas with other cells.

In Multi-RAT Dual Connectivity (MR-DC) cases, the primary cell of an MCG or an SCG may be called a SpCell. A PCell may refer to the SpCell of an MCG. A PSCell may refer to the SpCell of an SCG. MCG refers to a group of serving cells associated with the Master Node (MN), comprising the SpCell and optionally one or more SCells. SCG refers to a group of serving cells associated with the Secondary Node (SN), comprising of the SpCell and optionally one or more SCells.

In some implementations, the UE may not have (LTE/NR) RRC connections with the concerned serving cells of the associated services. In other words, the UE may not have UE-specific RRC signaling exchange with the serving cell. Instead, the UE may only monitor the DL synchronization signals (e.g., DL synchronization burst sets) and/or broadcasting system information (SI) related to the concerned services from such serving cells. In addition, the UE may have at least one serving cell on one or more target SL frequency carriers for the associated services. In some other implementations, the UE may consider the RAN which configures one or more of the serving cells as a serving RAN.

As previously disclosed, the frame structure for NR supports flexible configurations for accommodating various next-generation (e.g., 5G) communication requirements, such as eMBB, mMTC, and URLLC, while fulfilling high reliability, high data rate, and low latency requirements. The OFDM technology, as disclosed in 3GPP, may serve as a baseline for an NR waveform. The scalable OFDM numerology, such as the adaptive sub-carrier spacing, the channel bandwidth, and the cyclic prefix (CP), may also be used. Additionally, two coding schemes are considered for NR: (1) low-density parity-check (LDPC) code and (2) polar code. The coding scheme adaption may be configured based on the channel conditions and/or service applications.

It is also considered that in a transmission time interval of a single NR frame, at least DL transmission data, a guard period, and UL transmission data should be included. The respective portions of the DL transmission data, the guard period, and the UL transmission data should also be configurable, for example, based on the NW dynamics of NR. In addition, SL resources may also be provided in an NR frame to support ProSe services.

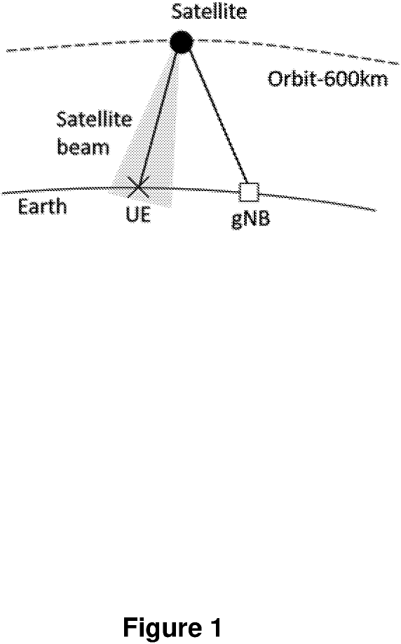

Please refer to FIG. 1, which is a system diagram illustrating an overview of an NTN according to an example implementation of the present disclosure. As shown in FIG. 1, an LEO satellite of transparent payload at orbit 600 kilometers (km) is presented to demonstrate the relation among a gNB, a satellite, and a UE with a satellite beam providing DL transmission. In some implementations, an NTN may refer to NWs, or segments of NWs, using a spaceborne vehicle for transmission, e.g., using LEO satellites. In the 3GPP Release 17 (Rel-17) NTN WI, transparent payload-based LEO NW addressing at least 3GPP Class 3 UE with GNSS capability and with both EFB and EMB footprint has been prioritized. More definitions are presented below:
Transparent payload-based LEO NW: May refer to a relay-based NTN. In this implementation, the LEO satellites simply perform amplify-and-forward in space, and the gNB is located on the ground connected to the core NW. The orbit of 600 km has been considered in the WI.
3GPP Class 3 UE: May refer to Power Class UE 3. The definition is used for the UL transmit (TX) power level set to be 23 decibel milliwatts (dBm) with a range of plus and minus 2 dB. This setting is mainly driven to ensure backward compatibility with prior technologies (e.g., Rel-15 NR/GSM/UMTS) so that NW deployment topologies remain similar.
GNSS: May refer to the standard generic term for satellite navigation systems that provide autonomous geo-spatial positioning with global coverage. This term includes, e.g., the Global Positioning System (GPS), Global Navigation Satellite System (GLONASS), Galileo, Beidou, and other regional systems.
EMB: May refer to the footprints of satellite beams on earth moving with the satellite. Cells on the ground are serviced by different beams with the satellite rotation.
EFB: May refer to the footprints of satellite beams on earth being fixed for a long time. The angle of the antenna for each beam can be adjusted during the moving of the satellite to provide service to a fixed area on earth for a long time. The major difference to the EMB situation is that the roundtrip time (RTT) for a statistic device varies with the elevation angle of beams, and each cell/area has the largest RTT with the minimum or maximum elevation angle.

In addition, the following definitions may be used to further elaborate terms, examples, embodiments, implementations, actions, behaviors, alternatives, aspects, or claims in the present disclosure.

### Timing Advance (TA)

In some implementations, TA refers to the timing offset between UL and DL frames. The UL frames may be transmitted in advance based on a TA value, indicated by the NW. This is used to guarantee UL signals from different UEs to be received at the NW side on time without interfering with each other. The typical TA value is set to two times the propagation delay. This value matters because the NW needs this information to:
perform UL time scheduling, e.g., UL grants and UL slot offsets;
ensure Layer 1 (L1) synchronization, e.g., the timing advance group (TAG)-specific timer defined in Rel-15 NR; and
enhance mobility, e.g., SMTC (Synchronization Signal Block (SSB) Measurement Timing Configuration) measurement gap and conditional HO.

In NTN, due to a large propagation delay, a UE may apply a large TA value. As a result, a large scheduling offset between its DL and UL frame timing may be needed.

### PUCCH Power Control

In NR, a Type-2 HARQ-ACK codebook is used for a UE to report HARQ-ACK information bits for PDSCH receptions with a DCI format scheduling, SPS PDSCH release/deactivation with a DCI format scheduling, SPS PDSCH retransmissions with a DCI format scheduling, and/or SPS PDSCH receptions without a DCI format scheduling.

A UL slot for the UE to transmit the HARQ-ACK codebook is indicated by K0 and K1 in the DCI format, where K0 is a slot offset for PDSCH receptions provided by a time domain resource assignment field in the DCI format and K1 is a slot offset for PUCCH transmission with the HARQ-ACK codebook provided by a PDSCH-to-HARQ_feedback timing indicator field in the DCI format.

The HARQ-ACK codebook size is determined by following scenario/condition:
A set of PDCCH monitoring occasions: The set has a total number M of PDCCH monitoring occasions in a serving cell based on the UL transmission slot indicated by K0 and K1. Alternatively, the set of PDCCH monitoring occasions is across active serving cells, indexed first across cells indexes and then indexed start times of search space sets.
A value of the counter DAI: This is provided by DCI format 1_0 or 1_1. The counter DAI (cDAI) denotes the accumulative number of PDSCH receptions or SPS PDSCH releases/deactivations associated with the DCI format(s), up to the current PDCCH monitoring occasion.
A value of the total DAI (tDAI): This is provided by DCI format 1_1. The tDAI denotes the total number of PDSCH receptions or SPS PDSCH releases/deactivations with associated DCI format(s), up to the current PDCCH monitoring occasion.
Based on the SPS PDSCH configuration: If the SPS PDSCH configuration is provided, one additional HARQ-ACK bit would be added in the end of the codebook. A UE does not expect to be instructed to transmit HARQ-ACK information for more than one SPS PDSCH reception in a same PUCCH if the UE is provided a single SPS PDSCH configuration in a cell group.

The HARQ-ACK information bits in the codebook are determined by:
If a UE receives a TB or a CBG scheduled by a corresponding DCI. Further, if the PDCCH monitoring occasion is before a DL or UL BWP change, the UE generates NACK value(s) corresponding of the received TB or CBG; otherwise, the UE generates HARQ-ACK information bit(s) corresponding to decoding results of the received TB or the received CBG.
If a UE does not receive a TB or a CBG due to the UE not detecting a corresponding DCI. Accordingly, no HARQ-ACK information bit is generated by the UE.

### BWP Operation

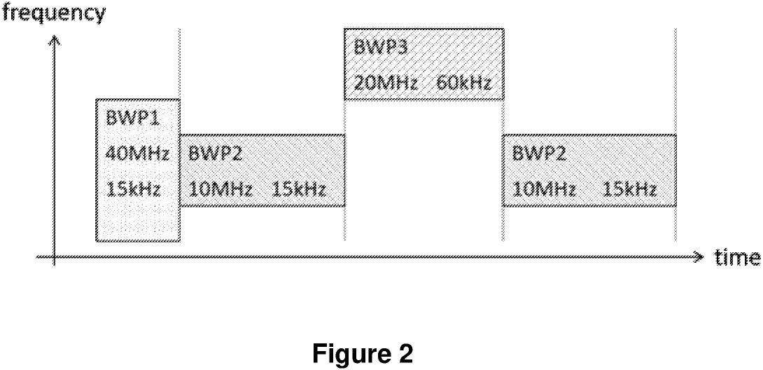

With BWP operation, the receive and transmit bandwidth of a UE may not be as large as the bandwidth of the cell and may be adjusted, the bandwidth may be ordered to change (e.g., to shrink during periods of low activity to save power), the location may move in the frequency domain (e.g., to increase scheduling flexibility), and the subcarrier spacing may be ordered to change (e.g., to allow different services). A subset of system bandwidth of a cell is referred to as a BWP, and bandwidth adaptation (BA) is achieved by configuring the UE with BWP(s) and informing the UE which of the configured BWPs is currently activated. Please refer to FIG. 2, which is a time/frequency diagram illustrating a scenario of three different BWPs being configured according to an example implementation of the present disclosure. As shown in FIG. 2, the three BWPs are BWP1, BWP2 and BWP3, where BWP1 is 40 MHz contiguous PRBs with subcarrier spacing of 15 kHz, BWP2 is 10 MHz contiguous PRBs with subcarrier spacing of 15 kHz, and BWP3 is 20 MHz contiguous PRBs with subcarrier spacing of 60 kHz.

In paired spectrum, DL and UL switch BWPs independently. In unpaired spectrum (used commonly for TDD), DL and UL switch BWPs simultaneously. The paired spectrum is to separate spectrum for NW-to-UE and LTE-to-NW links, usually used for FDD at lower-frequency bands. The unpaired spectrum is to use the same spectrum for NW-to-UE and LTE-to-NW links, which is a common use for TDD at higher-frequency bands.

BWP switching between configured BWPs happens by means of RRC signaling, DCI signaling, BWP inactivity timer, or upon initiation of random access. When a BWP inactivity timer is configured for a serving cell, the expiry of the BWP inactivity timer triggers the serving cell to switch the active BWP to a default BWP configured by the NW. There is at most one active BWP per cell, except when the serving cell is configured with SUL, in which case there may be at most one BWP on each UL carrier. More specifically, the BWP switching for a Serving Cell is used to activate an inactive BWP and deactivate an active BWP at a time. The BWP switching is controlled by the PDCCH indicating a DL assignment or a UL grant, by the bwp-InactivityTimer, by RRC signalling, or by the MAC entity itself upon initiation of an RA procedure or upon detection of consistent LBT (Listen-Before-Talk) failure on SpCell. Upon RRC (re-)configuration of firstActiveDownlinkBWP-Id and/or firstActiveUplinkBWP-Id for SpCell or activation of an SCell, the DL BWP and/or UL BWP indicated by firstActiveDownlinkBWP-Id and/or firstActiveUplinkBWP-Id, respectively (as specified in TS 38.331), is active without receiving PDCCH indicating a DL assignment or a UL grant. The active BWP for a Serving Cell is indicated by either RRC or PDCCH. For unpaired spectrum, a DL BWP is paired with a UL BWP, and BWP switching is common for both UL and DL.

No receiving or transmitting in a cell during a short period of time is required of a UE, if detecting a DCI format indicating a DL or UL BWP change for the cell. The time period is from the end of the third symbol of a slot where the UE receives the DCI format until the beginning of a slot indicated by the slot offset value of the time domain resource assignment field in the DCI format.

### Scheduling Enhancement in NTN

The existing NR timing definitions involving DL-UL timing interaction, e.g., an offset between a UL HARQ feedback and a DL PDSCH by K1, and an offset between a UL PUSCH and a DL DCI by K2 may not hold when there is a large offset in the DL and UL frame timing at the UE side in NTN.

In TR 38.821, the enhancement has been to introduce a new offset K_offset and apply it to modify the relevant timing relationships. The values of K _offset may be per-beam or per-cell. It is for further study whether the value is derived from broadcast information or is dedicatedly signaled by higher layers. The possibility of extending the value range of K1 and/or K2 beyond what is specified now may be further discussed when the specifications are developed. Note that to avoid scheduling disorder, e.g., a scheduled UL transmission being earlier than its scheduling DCI, the value of K_offset may be equal to or great than the current TA value if ignoring the impacts of K1 or K2.

### HARQ-ACK Disabling in NTN

In NTN, the propagation delays are from several milliseconds to hundreds of milliseconds depending on the satellite orbit. To prevent the reduction in peak data rates due to using only a small amount of parallel Stop-and-Wait HARQ processes, for example, 16 SAW (Stop-and-Wait) HARQ processes in Rel-15 NR, it has been agreed that the NW may disable UL HARQ feedback for DL transmission at the UE receiver to support long propagation delays.

More properties are captured in the current TR 38.821 listed below:
Even if HARQ feedback is disabled, the HARQ processes are still configured.
Enabling or disabling of HARQ feedback is a NW decision signaled semi-statically to the UE by RRC signaling.
The enabling or disabling of HARQ feedback for DL transmission should be configurable on a per-UE and per-HARQ process basis via RRC signaling.

If the new HARQ enhancements are introduced for NTN, some issues may occur by reusing the Type-2 HARQ-ACK codebook. For example, if disabling HARQ-ACK is configured per HARQ process or per UE,according to Rel-16 NR specifications, a UE may be forced to generate NACK values for PDCCH monitoring occasion(s) if the occasion(s) is before an active DL or UL BWP change; if the new scheduling offset K offset is configured, according to Rel-16 NR specifications (e.g., TS 38.213 V16.1.0), a UE may be forced to monitor PDSCH reception opportunities that will never happen and thus generate no bit in a HARQ-ACK codebook. Besides these, more issues are listed below:
General description for the Type-2 HARQ-ACK codebook may need a new offset.
SPS PDSCH reception, not scheduled by a DCI format, may need a new offset.
Redundant HARQ-ACK bits for obtaining PUCCH transmission power may need to be removed.
Interpretation of the DAI field when the disabling of HARQ-ACK is configured.

### HARQ-ACK Bits Before an Active UL or DL BWP Change

In Rel-16 NR, HARQ-ACK bits for a PDSCH scheduled by a PDCCH on a serving cell are NACK if the PDCCH does not trigger a DL BWP change and is before an active DL or UL BWP change on the serving cell.

Specifically, this scenario is introduced the pseudocode in 3GPP TS 38.213 V16.1.0 (2020-03) below:

while $c < {N}_{c e l l s}^{D L}$ if PDCCH monitoring occasion m is before an active DL BWP change on serving cell c
or an active UL BWP change on the PCell and an active DL BWP change is not triggered
in PDCCH monitoring occasion m
$\text{c = c + 1}$ else [...]
${\tilde{o}}_{{T}_{D} ⋅ j + {V}_{C - D A I , c , m}^{D L} - 1}^{A C K} = \text{HARQ-ACK}$ information bit of this cell ${V}_{S} = {V}_{S} ∪ \left\{{T}_{D} ⋅ j + {V}_{C - D A I , c , m}^{D L} - 1\right\} \left[…\right]$ end while [...]
${\tilde{o}}_{i}^{A C K} = \text{NACK}$ for any i ∈ {0,1, ..., 0^{ACK} - 1}\V_{S},

where some notations are presented in the following:
c: serving cell index

$${N}_{c e l l s}^{D L} :$$
the number of serving cells configured by higher layers for the UE
PCell: primary cell

$${\tilde{o}}_{i}^{A C K} :$$
an HARQ-ACK information bit determined by the UE
T_{D}: a set of
$${2}^{{N}_{C - D A I}^{D L}} ,$$
where
$${N}_{C - D A I}^{D L}$$
is the number of bits for the counter DAI
j: a parameter to convert the value of counter DAI to decimal
V_{S}: the decimal set of the counter DAIs received by the UE
U: the union of two sets
∈: belong to a set
0^{ACK}: a total number of HARQ-ACK information bits determined by the UE
\: set difference
[...]: ellipsis refers to omission or suppression of parts of words or sentences

$${V}_{C - D A I , c , m}^{D L} :$$
the value of the counter DAI on serving cell c in PDCCH monitoring occasion m

When the first “if” statement is met, e.g., m is before an active DL BWP change, the pseudocode goes for the next serving cell c + 1, without adding any cDAI to the set of V_{S} on the serving cell c. As a result, NACK value(s) will be padded in PDCCH monitoring occasion m after the pseudocode is finished.

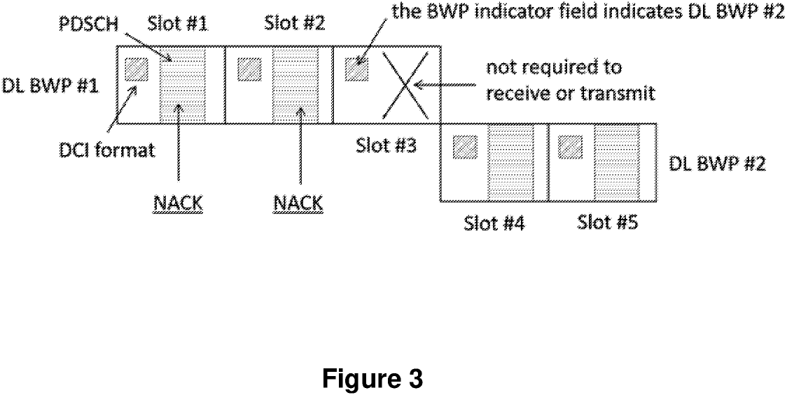

Please refer to FIG. 3, which is a timing diagram illustrating PDSCH receptions with an active DL BWP change via a DCI format according to an implementation of the present disclosure. As shown in FIG. 3, if Type-2 HARQ-ACK codebook is configured and if HARQ-ACK information bits for PDSCH reception of Slot #1 to Slot #5 are multiplexed on the same UL PUCCH slot, then the UE may send NACK values for Slot #1 and Slot #2, and send HARQ information bits corresponding to PDSCH receptions of Slot #4 and Slot #5. For Slot #3, there is no PDSCH reception, e.g., no HARQ-ACK information bit(s) may be generated.

Note that there is no UE behavior for an active DL or UL BWP change if a single SPS PDSCH reception is activated for a UE and the UE is configured to multiplex the corresponding HARQ-ACK information bit into the Type-2 HARQ-Ack codebook. Some related pseudocode from specifications (e.g., 3GPP TS 38.213 V16.1.0 (2002-03)) are presented below:

Set c = 0
while $c < {N}_{c e l l s}^{D L}$ if a single SPS PDSCH reception is activated for a UE and the UE is configured to
receive SPS PDSCH in a slot n - K_{1,c} for serving cell c, where K_{1,c} is the PDSCH-to-
HARQ-feedback timing value for SPS PDSCH on serving cell c
${O}^{A C K} = {O}^{A C K} + 1$ ${O}_{{O}^{A C K} - 1}^{A C K} = \text{HARQ-ACK}$
information bit associated with the SPS PDSCH
reception
end if $\text{c} \text{=} \text{c+1}$
end while

As shown above, for a single SPS PDSCH reception, there is only one HARQ-ACK information bit added after the HARQ-ACK information bits generated for PDSCH receptions and SPS PDSCH releases. However, no difference occurs if the SPS PDSCH reception is before or after an active DL or UL BWP change.

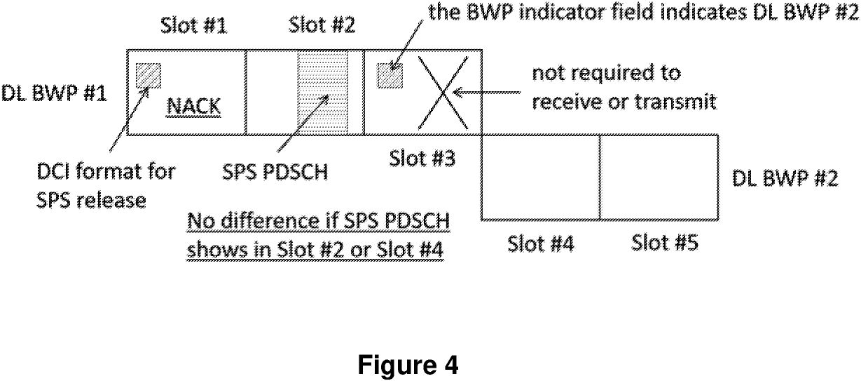

Please refer to FIG. 4, which is a timing diagram illustrating SPS PDSCH reception with an active DL BWP change via a DCI format according to an implementation of the present disclosure. As shown in FIG. 4, a scheduled Type-2 HARQ-ACK codebook simply contains an SPS release and an SPS PDSCH reception. The SPS release indicated by a DCI format follows the same rule as a PDSCH reception that a NACK value shall be generated by the UE. However, for SPS PDSCH reception, no matter whether it presents in Slot #2 on the old DL BWP #1 or in Slot #4 on the new DL BWP #2, the UE may generate a HARQ-ACK information bit based on the decoding result of the SPS PDSCH reception.

Note that for an SPS PDSCH reception, it is redundant to feedback HARQ information bits on a deactivated DL BWP, e.g., DL BWP #1 in FIG. 4. This is because retransmission for soft combining is impossible after the NW clears configured DL assignment on the deactivated BWP, e.g., mcs-Table in SPS-Config field used to indicate the MCS table that the UE may use for DL SPS. Some related pseudocode from specifications (e.g., 3GPP TS 38.321 V16.0.0 (2020-03)) are presented below:

For each activated Serving Cell configured with a BWP, the MAC entity may: [...] 1> if a BWP is deactivated:
2> not transmit on UL-SCH on the BWP
2> not transmit on RACH on the BWP
2> not monitor the PDCCH on the BWP
2> not transmit PUCCH on the BWP
2> not report CSI for the BWP
2> not transmit SRS on the BWP
2> not receive DL-SCH on the BWP
2> clear any configured DL assignment and configured UL grant of configured grant Type 2 on the BWP
2> suspend any configured UL grant of configured grant Type 1 on the inactive BWP [...]

In Rel-17 NTN, these redundant bits may need to be revisited when HARQ and DL SPS enhancement are introduced (for example, whether the redundant NACK bits keep being generated with a BWP change, even if HARQ-ACK is disabled by the NW, or whether the enhanced DL SPS may have a new UE behavior to avoid the redundant feedback of the HARQ-ACK information bits).

In some implementations, in Rel-16 NR, a general description for the Type-2 HARQ-ACK codebook is highly involved with the scheduling offset K0 and the scheduling offset K1 indicated by a PDSCH-to-HARQ_feedback timing indicator field. As introduced in the specification (e.g., 3GPP TS 38.213 V16.1.0 (2020-03)), a UE determines monitoring occasions for PDCCH with DCI format scheduling PDSCH receptions or SPS PDSCH release on an active DL BWP of a serving cell c, as described in Clause 10.1, and for which the UE transmits HARQ-ACK information in a same PUCCH in slot n based on:
PDSCH-to-HARQ_feedback timing indicator field values: This is for PUCCH transmission with HARQ-ACK information in slot n in response to PDSCH receptions or SPS PDSCH release.
slot offsets K0: This is provided by a time domain resource assignment field in a DCI format scheduling PDSCH receptions or SPS PDSCH release and by pdsch-AggregationFactor, when provided.

For Rel-17 NTN, if the new scheduling offset K_offset is configured, the determination may need a new input parameter to accommodate Rel-16 NR.

### SPS PDSCH Reception

In Rel-16 NR, if DL SPS is configured to a UE in UL slot n, the UE determines an SPS PDSCH reception based on the slot number of n and the offset K1. Some related pseudocode from specifications (e.g., 3GPP TS 38.213 V16.0.0 (2019-06)) are presented below:

Set c = 0
while $c < {N}_{c e l l s}^{D L}$ if a single SPS PDSCH reception is activated for a UE and the UE is configured to
receive SPS PDSCH in a slot n - K_{1,c} for serving cell c, where K_{1,c} is the PDSCH-to-
HARQ-feedback timing value for SPS PDSCH on serving cell c ${O}^{A C K} = {O}^{A C K} + 1$
${O}_{{O}^{A C K} - 1}^{A C K} = \text{HARQ-ACK}$ information bit associated with the SPS PDSCH reception
end if $\text{c = c+1}$
end while

For NTN, if the scheduling offset K offset is provided, the determination may need some modifications.

### PUCCH Power Control for UCI Size Smaller Than 11

In Rel-16 NR, if a UCI size determined by a UE is smaller than 11 bits, the UE determines a different number of HARQ-ACK information bits for obtaining a transmission power for a PUCCH. Some introductions from specifications (e.g., 3GPP TS 38.213 V16.0.0 (2020-03)) are presented below:
If a UE is not provided PDSCH-CodeBlockGroupTransmission for each of the
$${N}_{c e l l s}^{D L}$$
serving cells, or for PDSCH receptions scheduled by a DCI format that does not support CBG-based PDSCH receptions, or for SPS PDSCH reception, or for SPS PDSCH release, and if 0_{ACK} + 0_{SR} + 0_{CSI} ≤ 11, the UE determines a number of HARQ-ACK information bits n_{HARQ-ACK} for obtaining a transmission power for a PUCCH, as described in Clause 7.2.1, as:
$${n}_{\text{HARQ-ACK}} = {\underbrace{\left(\left({V}_{D A I , {m}_{l a s t}}^{D L} - {\sum }_{c = 0}^{{N}_{c e l l s}^{D L}} {U}_{D A I , c}\right) m o d \left({T}_{D}\right)\right) {N}_{T B , m a x}^{D L}}}_{A}$$
$$+ {\underbrace{{\sum }_{c = 0}^{{N}_{c e l l {s}^{- 1}}^{D L}} \left({\sum }_{m = 0}^{M - 1} {N}_{m , c}^{r e c e i v e d} + {N}_{S P S , c}\right)}}_{B} {n}_{H A R Q - A C K}$$
$$= \left(\left({V}_{D A I , {m}_{l a s t}}^{D L} - {\sum }_{c = 0}^{{N}_{c e l l {s}^{- 1}}^{D L}} {U}_{D A I , c}\right) m o d \left({T}_{D}\right)\right) {N}_{T B , max}^{D L}$$
$$+ {\sum }_{c = 0}^{{N}_{c e l l {s}^{- 1}}^{D L}} \left({\sum }_{m = 0}^{M - 1} {N}_{m , c}^{r e c e i v e d} + {N}_{S P S , c}\right)$$
where the above notations are defined as

$${N}_{D A I , {m}_{l a s t}}^{D L} :$$
the value of cDAI or tDAI in the last DCI format
U_{DAI,c}: the total DCI formats with PDSCH or SPS PDSCH release that the UE detects

$${N}_{T B , max}^{D L} :$$
the max number of codewords scheduled by a DCI format
mode(·): the modulo operation that finds the remainder after division

$${N}_{m , c}^{r e c e i v e d} :$$
the number of TBs or SPS PDSCH release that the UE receives
N_{SPS,c}: the number of SPS PDSCH receptions that the UE receives

Note that in the above equation, the ‘A’ part is to count the number of missed DCI formats, and the ‘B’ part is to calculate the number of received PDSCHs and SPS releases. Note that the determined number is always equal to or smaller than the HARQ-ACK codebook size, e.g., n_{HARQ-ACK} ≤ 0_{ACK}, and it is always smaller than the codebook size when there are more than T_{D} DCI formats missed.

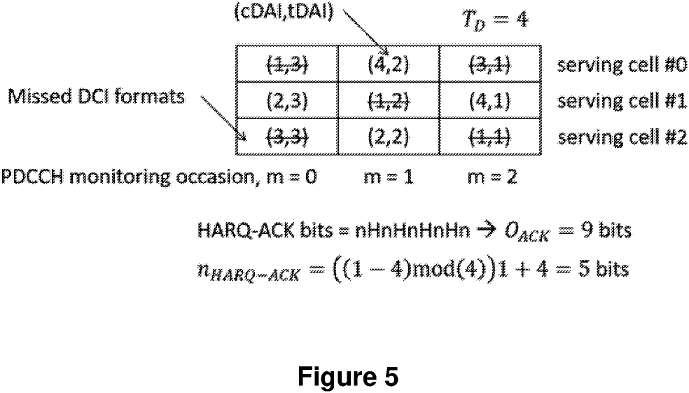

Please refer to FIG. 5, which is a timing diagram illustrating a Type-2 HARQ-ACK codebook with more than T_{D}=4 missed DCI formats according to an implementation of the present disclosure. Since cDAI are not lost consecutively for more than 3 times, e.g., missed detection for cDAI = 1, 2, 3, and 4 successively, the UE may still derive correct HARQ-ACK information bits as O_{ACK}=9 bits in the example. Some notations are introduced below:
n: a NACK value
H: a HARQ-ACK information value generated by the UE by decoding the received TB

$${V}_{D A I , {m}_{l a s t}}^{D L} = 1 :$$
the codebook size 9 mod 4 = 1
U_{DAI,c} = 4: the UE detects 4 DCI formats with PDSCH or SPS release
T_{D} = 4: the DCI format contains 2 bits for cDAI or tDAI indication

$${N}_{T B , max}^{D L} = 1 :$$
one DCI format results in one HARQ information bit
N_{SPS,c} = 0: no DL SPS scheduling in this codebook

Based on the above parameters, the UE determines n_{HARQ-ACK} = 5 bits by eliminating 4 bits from the 5 missed DCI formats. Those NACK values may be less important than the HARQ-ACK information bits associated with detected DCI formats for obtaining PUCCH transmission power.

Note that BWP switching has not been considered in the current specifications. For example, if all the monitoring occasions are before an active DL or UL BWP change, a UE may feedback only NACK bits without any valuable information to the NW. However, the UE will not eliminate any bit for obtaining transmission power of PUCCH when the UCI size is smaller than 11. This is against the design principle of using n_{HARQ-ACK}.

For NTN, if disabling of HARQ-ACK is configured and if a UL or DL BWP change is present, the determination of the HARQ-ACK information bits for obtaining PUCCH transmission power may be revised. Redundant bits may be removed following some design principles.

### DAI Field with HARQ-ACK Disabling

The field of DAI is redundant when HARQ-ACK is disabled. In order to remove the field of DAI, DCI format 1_1 may support 0 bits of the DAI field. Also, since DCI format 1_0 has a fixed bit length of 2, it is problematic that DCI 1_0 may not provide 0 bits and 00′ in the DCI 1_0 (i.e. cDAI = 1). Thus, there are some alternatives presented below:
For DCI format 1_1: If the HARQ process number field indicates a number associated with HARQ-ACK disabling (or called HARQ-ACK being disabled), the UE may ignore the DAI field. In one example, the DAI field may be configured with zero bits for DCI format 1_1 if one UE with HARQ-ACK disabling is indicated.
For DCI format 1_0: If the HARQ process number field indicates a number associated with HARQ-ACK disabling, the UE may ignore the DAI field. In one example, DCI format 1_0 is restricted from DL scheduling if one UE with HARQ-ACK disabling is indicated.
New RNTI may be introduced to redefine the fields of DCI format 1_0 and/or DCI format 1_1 when HARQ-ACK disabling is configured by the NW.

Note that if a UE detects successive DCI formats, with associated PDSCH reception, indicating the same cDAI value, e.g., the condition of

$${V}_{C - D A I , c , m}^{D L} \leq {V}_{t e m p}$$

in the pseudocode may be met, the UE determines (T_{D} - 1) DCI formats missed and pads NACKs in the HARQ-ACK codebook. Any new interpolation for receiving the same cDAI may lose the correction capability.

A better way is to keep DAI unchanged and to add a new procedure for removing the disabled HARQ-ACK bits after the HARQ-ACK codebook is determined, which may improve the specification with the least modifications and/or changes.

In some implementations, for the HARQ-ACK codebook determination, if the scheduling offset K offset is configured, new UE behaviors may be needed upon the Rel-16 Type-2 HARQ-ACK codebook. Some solutions are presented in the below:
Adding a new definition for the slot offset. In one example, the slot offset value may at least include K_offset and K1.
Adding K offset to the slot offset defined in Rel-16 NR. In one example, the new offset K_offset may be added directly to the statements of the slot offset.

For PDSCH reception or SPS release, if HARQ-ACK disabling is provided, new UE behaviors may be needed when a monitoring occasion is before an active DL or UL BWP change. Some solutions are presented below:
Drop redundant HARQ-ACK bit(s) if it is for a HARQ-ACK bit associated with a HARQ-ACK disabling process ID; alternatively, if an NTN scenario is identified, e.g., k_offset is configured, or HARQ-ACK disabling is indicated on per UE basis, or a new parameter indicates a dynamic codebook for NTN, e.g., pdsch-HARQ-ACK-Codebook = NTNdynamic.
Keep redundant NACK bits by ignoring at least one HARQ-ACK bit(s) indicated as HARQ-ACK disabling. For example, no HARQ-ACK bits are generated if no BWP change. If there is a BWP change, a UE may be forced to feedback NACKs for PDSCH reception or SPS release, and feedback a HARQ-ACK bit for SPS PDSCH.
MAC entity may not indicate ACK for the SPS deactivation to the physical layer.

If the UE receives the DCI that indicates SPS deactivation, the MAC entity of the UE may not indicate ACK for the SPS deactivation to the physical layer when the UE is configured with HARQ-ACK disabling for a HARQ process (e.g., if the HARQ process ID is included in harq-ACK-Disabled-List or the harq-ACK-Disabled-per-UE is set as true/valid). For PUCCH transmission power determination, if HARQ-ACK disabling is provided, new UE behaviors may be needed. Some solutions are presented in the below:
Redundant bits in the number of received PDSCHs and SPS releases may be removed if it is determined that the reception or release is associated with a HARQ-ACK disabling process ID or the reception or release is associated with a monitoring occasion, which is before an active UL or DL BWP change.
Remove all bits if HARQ-ACK disabling is on a per-UE basis. In one example, a number (e.g., 0) is used for PUCCH transmission power derivation. In another example, a default number (e.g., 1) may be used for PUCCH transmission power derivation.
Keep redundant bits by ignoring the indication of HARQ-ACK disabling.

For removing disabled HARQ-ACK bits, a new procedure may be added in the end of the pseudocode as presented in 3GPP TS specifications, e.g., removing disabled HARQ-ACK bits after the HARQ-ACK codebook is determined. In one example, a flag may be added during HARQ-ACK codebook determination when the UE detects a PDSCH reception or SPS release scheduled by a DCI format that is associated with HARQ-ACK disabling. In another example, the flags may be used to remove bits associated with the DCI receptions indicating HARQ-ACK disabling in the end of the mentioned pseudocode.

### Receiving From NW to UE

In some implementations, RRC signaling may configure, via RRC messages, from NW to UE the following parameters:
pdsch-HARQ-ACK-Codebook: This may be configured to semi-static (Type-1 HARQ-ACK codebook), dynamic (Type-2 HARQ-ACK codebook), enhancedDynamic-r16 (Type-2 HARQ-ACK codebook for Rel-16 NR-U), or NTNdynamic (enhanced Type-2 HARQ-ACK codebook for Rel-17 NTN).
pdsch-AggregationFactor: This is the number of repetitions for data. If absent, the value is 1.
dl-DataToUL-ACK: This is the list of timing for a given PDSCH to the DL ACK in slot.
bwp-InactivityTimer: This is the duration after which the UE falls back to the default BWP.
firstActiveDownlinkBWP-Id: This field contains the DL-BWP ID to be activated upon performing the RRC (re-)configuration.
firstActiveUplinkBWP-Id: This field contains the ID of the UL BWP to be activated upon performing the RRC (re-)configuration.
dl-DataToUL-ACK-NTN: This is the list of timing for a given PDSCH to the DL ACK for NTN.
K_offset-NTN: This is a new timing offset K offset for a given DL to UL.
harq-ACK-Disabled-List: This is the list of HARQ processes ID(s) for HARQ-ACK disabling.
harq-ACK-Disabled-per-UE: This is the identifier for disabling HARQ-ACK processes on a per-UE basis.

In some implementations, the physical layer may indicate, via DCI formats, from NW to UE the following information:
PDSCH-to-HARQ_feedback timing indicator field. It further specifies slot offsets K1 for PUCCH transmission with HARQ-ACK information in slot n in response to PDSCH receptions or SPS PDSCH release. For DCI format 1_0, the field values map to {1, 2, 3, 4, 5, 6, 7, 8}. For DCI format 1_1, the field values map to values for a set of the number of slots provided by dlDataToUL-ACK or dl-DataToUL-ACK-NTN, if configured. In one example, the set provided by dl-DataToUL-ACK-NTN may contain a non-numerical value, e.g., an inapplicable value, for HARQ-ACK codebook determination. In another example, when a non-numerical value is indicated, the UE ignores the corresponding HARQ feedback.
Time domain resource assignment field. It further specifies slot offsets K0 provided in a DCI format scheduling PDSCH receptions or SPS PDSCH release and by pdsch-AggregationFactor, when provided.
DAI field. In one example, it further specifies a value of the counter DAI, e.g., the cumulative number of {serving cell, PDCCH monitoring occasion}-pair(s) in which PDSCH reception(s) or SPS PDSCH release associated with the DCI formats is present up to the current serving cell and current PDCCH monitoring occasion. In another example, it further specifies a value of the total DAI, e.g., the total number of {serving cell, PDCCH monitoring occasion}-pair(s) in which PDSCH reception(s) or SPS PDSCH release associated with DCI formats is present, up to the current PDCCH monitoring occasion m and is updated from PDCCH monitoring occasion to PDCCH monitoring occasion. In another example, for DCI format 1_1, the DAI field may be configured by a 0 bit or by a non-numerical value, e.g., an inapplicable value, for HARQ-ACK codebook determination. When a non-numerical value is indicated, the UE ignores the corresponding HARQ feedback.
BWP indicator field. In one example, this field contains the DL-BWP ID to be activated for DCI format 1_1, or contains the UL-BWP ID to be activated for DCI format 0_1. In another example, a UE ignores this bit field if the UE may not support active BWP change via DCI.

### Transmission From UE to NW

HARQ-ACK information bits associated with PDSCH reception, SPS PDSCH reception and SPS PDSCH release scheduled by NW in an active DL BWP of a serving cell, may be transmitted from UE to NW in a PUCCH transmission or multiplexed in a PUSCH transmission in one slot.

### UE Behaviors

In some implementations, solutions in this section may be applied if the UE is configured with pdsch-HARQ-ACK-Codebook = dynamic or pdsch-HARQ-ACKCodebook = NTNdynamic.

A UE determines monitoring occasions for PDCCH with DCI format scheduling PDSCH receptions or SPS PDSCH release on an active DL BWP of a serving cell c, and for which the UE transmits HARQ-ACK information in a same PUCCH in slot n based on K0, K1, and based on K_offset, when provided.

### Enhanced Type-2 HARQ-ACK Codebook for NTN

The UE determines the

$${\tilde{o}}_{0}^{A C K} , {\tilde{o}}_{1}^{A C K} , … , {\tilde{o}}_{{o}_{A C {K}^{- 1}}}^{A C K}$$

for a total number of 0_{ACK} HARQ-ACK information bits, according to the following pseudocode:

### Initialization

Set m = 0; Set j = 0; Set Vₜₑₘₚ = 0; Set Vₛ = Ø.

Set V_{R} = Ø as the set of redundant bits to be removed.

Set

$${N}_{c e l l s}^{D L}$$

to the number of serving cells configured by higher layers for the UE.

Set M to the number of PDCCH monitoring occasion(s).

### PDSCH and SPS Release

while m < M
Set c = 0
while $c < {N}_{c e l l s}^{D L}$ if PDCCH monitoring occasion m is before an active DL BWP change on serving
cell c or an active UL BWP change on the PCell and an active DL BWP change is
not triggered in PDCCH monitoring occasion m
if pdsch-HARQ-ACKCodebook = NTNdynamic
if ${V}_{C - D A I , c , m}^{D L} \leq {V}_{t e m p}$ j=j+1
end if
${V}_{t e m p} = {V}_{C - D A I , c , m}^{D L}$ ${V}_{R} = {V}_{R} ∪ \left\{{T}_{D} ⋅ j + {V}_{C - D A I , c , m}^{D L} - 1\right\}$ else
c=c+1
end if
else
if there is a PDSCH on serving cell c associated with PDCCH in PDCCH monitoring occasion m, or there is a PDCCH indicating SPS PDSCH release on serving cell c
if ${V}_{C - D A I , c , m}^{D L} \leq {V}_{t e m p}$ j=j+1
end if
${V}_{t e m p} = {V}_{C - D A I , c , m}^{D L}$ if ${V}_{T - D A I , m}^{D L} = ∅$ ${V}_{t e m p 2} = {V}_{C - D A I , c , m}^{D L}$
else
${V}_{t e m p 2} = {V}_{T - D A I , m}^{D L}$ end if
if harq-ACK-SpatialBundlingPUCCH is not provided and the UE is configured by maxNrofCodeWordsScheduledByDCI with reception of two TBs for at least one configured DL BWP of at least one serving cell,
[...] (specified in TS 38.213, e.g., V16.1.0) else if harq-ACK-SpatialBundlingPUCCH is provided to the UE and m is a monitoring occasion for PDCCH with a DCI format that supports PDSCH reception with two TBs and the UE is configured by maxNrofCodeWordsScheduledByDCI with reception of two TBs in at least one configured DL BWP of a serving cell,
[...] (specified in TS 38.213 e.g., V16.1.0)
else
${\tilde{o}}_{T D ⋅ j + {V}_{C - D A I , c , m {}^{- 1}}^{D L}}^{A C K} = \text{HARQ} - \text{ACK}$ information bit of this cell
${V}_{S} - {V}_{S} ∪ \left\{{T}_{D} ⋅ j + {V}_{C - D A I , c , m}^{D L} - 1\right\}$
if pdsch-HARQ-ACKCodebook = NTNdynamic
if there is a HARQ process number field with PDCCH in
PDCCH monitoring occasion m and a HARQ process
number provided to the UE is associated with HARQ-ACK
disabling, provided by harq-ACK-Disabled-List or by harq-
ACK-Disabled-per-UE
${V}_{R} = {V}_{R} ∪ \left\{{T}_{D} ⋅ j + {V}_{C - D A I , c , m}^{D L} - 1\right\}$
end if
end if
end if
end if
c=c+1
end if
end while
m=m+1
end while

### Check for a Carry for tDAI

if Vₜₑₘₚ₂ < Vₜₑₘₚ $j = j + 1$
end if

### For SPS PDSCH

set c = 0
while $c < {N}_{c e l l s}^{D L}$ if a single SPS PDSCH reception is activated for a UE and the UE is configured to
receive SPS PDSCH in a slot n - K_{1,c} for serving cell c, where K_{1,c} is the PDSCH-to-
HARQ-feedback timing value for SPS PDSCH on serving cell c, or a slot n - K_{1,c} -
K_{offset,c} for serving cell c, where K_{offset,c} is a scheduling offset provided by K offset-
NTN, if configured.
If pdsch-HARQ-ACKCodebook = NTNdynamic is provided to the UE and if the
slot of the SPS PDSCH reception is before an active DL BWP change on serving
cell c or an active UL BWP change on the PCell; or
if pdsch-HARQ-ACKCodebook = NTNdynamic is provided to the UE and if the
slot of the SPS PDSCH reception is in the same slot where an active BWP change
is triggered
$c = c + 1$
else ${O}_{A C K} = {O}_{A C K} + 1$
${O}_{{O}_{A C K} - 1}^{A C K} = \text{HARQ-ACK}$ information bit associated with the SPS PDSCH
reception
if the HARQ Process ID associated with the slot where the DL
transmission starts, derived by the UE from the equation in 3GPP TS
38.321 e.g., V16.0.0, is associated with HARQ-ACK disabling, provided
by harq-ACK-Disabled-List or by harq-ACK-Disabled-per-LTE
${V}_{R} = {V}_{R} ∪ \left\{{O}_{A C K} - 1\right\}$
end if
end if
end if
$c = c + 1$
end while

### Padding NACK and Removing Redundant Bits

$${\tilde{o}}_{i}^{A C K} = \text{NACK}$$

for any i ∈ {0,1, ..., 0^{ACK} - 1}\V_{S}

$${\tilde{o}}_{i}^{A C K} = < \text{NULL >}$$

(remove the HARQ-ACK information bit) for any i ∈ V_{R}

### Preclude HARQ-ACK Bits Before Multiplexing in a HARQ-ACK Codebook

A UE determines monitoring occasions for PDCCH with a DCI format scheduling PDSCH receptions or SPS PDSCH release on an active DL BWP of a serving cell, and for which the UE transmits HARQ-ACK information in a same PUCCH in slot n based on K0, K1, and based on K_offset, when provided.

In one example, if pdsch-HARQ-ACKCodebook = NTNdynamic is provided and further if a HARQ process number field in the DCI format indicates a HARQ process number that is associated with HARQ-ACK disabling, provided by harq-ACK-Disabled-List or by harq-ACK-Disabled-per-UE, the UE may not multiplex HARQ-ACK information bit(s) for PUCCH transmission in slot n.

In another example, if a DAI field provided by the DCI format is configured by a 0 bit or by a non-numerical value, and further if a HARQ process number field in the DCI format 1_1 indicates a HARQ process number associated with HARQ-ACK disabling, provided by harq-ACK-Disabled-List or by harq-ACK-Disabled-per-UE, the UE may not multiplex HARQ-ACK information bit(s) for PUCCH transmission in slot n.

In another example, if there is a PDSCH-to-HARQ_feedback timing indicator field in the DCI format providing a non-numerical value from dl-DataToUL-ACK-NTN, the UE may not multiplex HARQ-ACK information bit(s) for PUCCH transmission in slot n.

In another example, if none of the above scenarios is met, the UE may apply the legacy process.

In one implementation, the MAC entity of the UE does not instruct the physical layer to generate ACKs of the data in this TB if the corresponding HARQ process is disabled (e.g., the HARQ process ID is included in harq-ACK-Disabled-List or the harq-ACK-Disabled-per-UE is set as true). Some related pseudocode is presented below:
1> if the HARQ process is associated with a transmission indicated with a Temporary C-RNTI and the Contention Resolution is not yet successful; or
1> if the HARQ process is associated with a transmission indicated with a MSGB-RNTI and the RA procedure is not yet successfully completed; or
1> if the HARQ process is equal to the broadcast process;
1> if the HAQR process is disable (e.g., the HARQ process ID is included in harq-ACK-Disabled-List or the harq-ACK-Disabled-per-UE is set as true); or
1> if the timeAlignmentTimer, associated with the TAG containing the Serving Cell on which the HARQ feedback is to be transmitted, is stopped or expired: 2> not instruct the physical layer to generate ACKs of the data in this TB.
1> else: 2> instruct the physical layer to generate ACKs of the data in this TB.

### Determination for PUCCH Power Control

If a UE is not provided PDSCH-CodeBlockGroupTransmission for each of the

$${N}_{c e l l s}^{D L}$$

serving cells, or for PDSCH receptions scheduled by a DCI format that does not support CBG-based PDSCH receptions, or for SPS PDSCH reception, or for SPS PDSCH release, and if 0_{ACK} + 0_{SR} + 0_{CSI} ≤ 11, the UE determines a number of HARQ-ACK information bits n_{HARQ-ACK} for obtaining a transmission power for a PUCCH, as described in Clause 7.2.1, as

$${n}_{H A R Q - A C K} = \left(\left({V}_{D A I , {m}_{l a s t}}^{D L} - {\sum }_{c = 0}^{{N}_{c e l l s}^{D L} - 1} {U}_{D A I , c}\right) m o d \left({T}_{D}\right)\right) {N}_{T B , m a x}^{D L}$$

$$+ {\sum }_{c = 0}^{{N}_{c e l l s}^{D L} - 1} \left({\sum }_{m = 0}^{M - 1} {N}_{m , c}^{r e c e i v e d} + {N}_{S P S , c}\right) - \overline{N}$$

where

$${N}_{m , c}^{r e c e i v e d}$$
is the number of TBs the UE receives in a PDSCH scheduled by a DCI format that the UE detects in PDCCH monitoring occasion m for serving cell c if harq-ACK-SpatialBundlingPUCCH is not provided, or the number of PDSCH scheduled by a DCI format that the UE detects in PDCCH monitoring occasion m for serving cell c if harq-ACK-SpatialBundlingPUCCH is provided, or the number of DCI format that the UE detects and indicate SPS PDSCH release in PDCCH monitoring occasion m for serving cell c.
N_{SPS,c} is the number of SPS PDSCH receptions by the UE on serving cell c for which the UE transmits corresponding HARQ-ACK information in the same PUCCH as for HARQ-ACK information corresponding to PDSCH receptions within the M PDCCH monitoring occasions.
If pdsch-HARQ-ACK-Codebook = NTNdynamic is provided to the UE, N̅ is the number of HARQ-ACK information bits removed by the UE, e.g., the cardinality of V_{R}, due to an active DL or UL BWP change, or due to HARQ-ACK disabling. Otherwise, N̅ = 0.

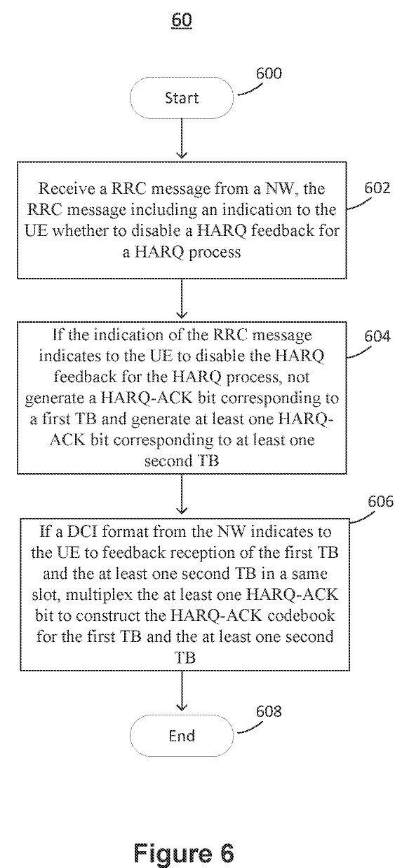

Please refer to FIG. 6, which is a flowchart illustrating a procedure 60 for HARQ-ACK codebook construction performed by a UE according to an implementation of the present disclosure. As shown in FIG. 6, the procedure 60 for the UE includes the following actions:

Action 600: Start.

Action 602: Receive an RRC message from a NW, the RRC message including an indication to the UE whether to disable a HARQ feedback for a HARQ process.

Action 604: If the indication of the RRC message indicates to the UE to disable the HARQ feedback for the HARQ process, not generate a HARQ-ACK bit corresponding to a first TB and generate at least one HARQ-ACK bit corresponding to at least one second TB.

Action 606: If a DCI format from the NW indicates to the UE to feedback reception of the first TB and the at least one second TB in a same slot, multiplex the at least one HARQ-ACK bit to construct the HARQ-ACK codebook for the first TB and the at least one second TB.

Action 608: End.

Preferably, action 602 to action 606 of the procedure 60 may be performed by the UE. Specifically, the indication of the RRC message configures a harq-ACK-Disabled-List parameter to include a list of HARQ process(es) that the HARQ feedback is disabled, and the HARQ-ACK codebook is a Type-2 HARQ-ACK codebook, and the NW is an NTN.

In some implementations, the UE may receive the RRC message from the NW, such that the NW may indicate, via the indication of the RRC message, to the UE whether to disable the HARQ feedback for the HARQ process in action 602. In action 604, if the NW indicates to the UE to disable the HARQ feedback for the HARQ process, the UE may not generate the HARQ-ACK bit corresponding to one TB (e.g., the first TB) but may generate at least one HARQ-ACK bit corresponding to other TB(s) (e.g., the at least one second TB). In action 606, if a DCI format from the NW indicates to the UE to feedback reception of the TBs (e.g., including the first TB and the at least one second TB) in the same slot, the UE may multiplex the at least one HARQ-ACK bit to construct the HARQ-ACK codebook for the first TB and the at least one second TB.

The procedure 60 may include further actions/procedures/mechanisms/operations. In some implementations, if the indication of the RRC message indicates to the UE to disable the HARQ feedback for the HARQ process, the UE may drop at least one HARQ-ACK bit associated with the HARQ process that is disabled(e.g., the HARQ process with disabled feedback).

In some implementations, the UE may receive a DCI message from the NW. Next, if the one HARQ-ACK bit associated with a disabled HARQ process ID is dropped, the UE may ignore a DAI field of the DCI message.

In some implementations, if a transmission for one TB is indicated with a T-CRNTI and a contention resolution corresponding to the transmission is not yet successful, or if the HARQ process associated with the transmission is indicated with a MSGB-RNTI and an RA procedure is not yet successfully completed, or if the HARQ process is equal to a broadcast process, or if a TimeAlignment timer associated with a tag, which includes a serving cell on which the HARQ feedback is to be transmitted, is expired or stopped, the UE may not generate the HARQ-ACK bit corresponding to the one TB.

Certainly, the detailed mechanisms and/or operations for the procedure 60 are described in the above paragraphs and omitted hereinafter for brevity. For example, the detailed mechanisms and/or operations for action 602 to action 606 are described in the above paragraphs and omitted hereinafter for brevity.

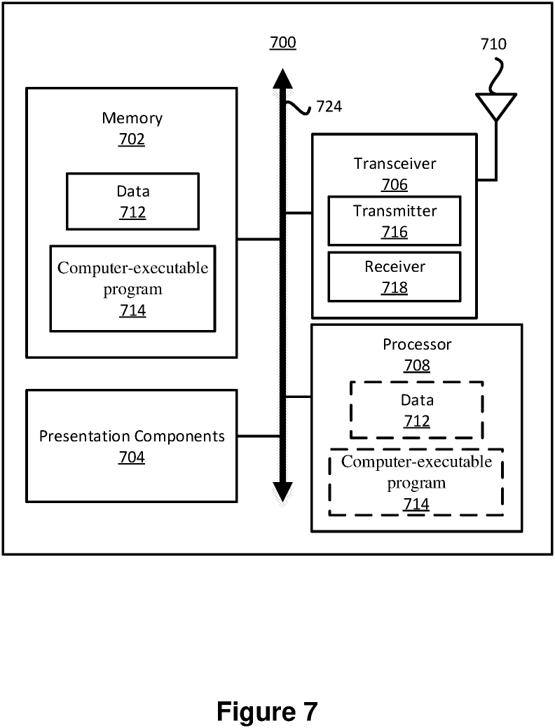

Please refer to FIG. 7, which is a block diagram illustrating a node 700 for wireless communication according to an implementation of the present disclosure. As illustrated in FIG. 7, the node 700 includes a transceiver 706, a processor 708, a memory 702, one or more presentation components 704, and at least one antenna 710. The node 700 may also include a Radio Frequency (RF) spectrum band module, a BS communications module, an NW communications module, and a system communications management module, input/output (I/O) ports, I/O components, and power supply (not explicitly illustrated in FIG. 7). Each of these components may be in communication with each other, directly or indirectly, over one or more buses 724. The node 700 may be a UE or a BS that performs various functions disclosed herein, for example, with reference to FIG. 6.

The transceiver 706 includes a transmitter 716 (e.g., transmitting/transmission circuitry) and a receiver 718 (e.g., receiving/reception circuitry) and may be configured to transmit and/or receive time and/or frequency resource partitioning information. The transceiver 706 may be configured to transmit in different types of subframes and slots, including, but not limited to, usable, non-usable and flexibly usable subframes and slot formats. The transceiver 706 may be configured to receive data and control channels.

The node 700 may include a variety of computer-readable media. Computer-readable media may be any available media that may be accessed by the node 700 and include both volatile (and non-volatile) media and removable (and non-removable) media. By way of example, and not limitation, computer-readable media may include computer storage media and communication media. Computer storage media may include both volatile (and non-volatile) and removable (and non-removable) media implemented according to any method or technology for storage of information such as computer-readable.

Computer storage media includes RAM, ROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer storage media does not include a propagated data signal. Communication media may typically embody computer-readable instructions, data structures, program modules, or other data in a modulated data signal such as a carrier wave or other transport mechanism and include any information delivery media.

The term “modulated data signal” may refer to a signal that has one or more of its characteristics set or changed in such a manner as to encode information in the signal. By way of example, and not limitation, communication media may include wired media such as a wired NW or direct-wired connection, and wireless media such as acoustic, RF, infrared and other wireless media. Combinations of any of the previous disclosure should also be included within the scope of computer-readable media.

The memory 702 may include computer-storage media in the form of volatile and/or non-volatile memory. The memory 702 may be removable, non-removable, or a combination thereof. For example, the memory 702 may include solid-state memory, hard drives, optical-disc drives, etc.

As illustrated in FIG. 7, the memory 702 may store a computer-executable (or readable) program 714 (e.g., software codes) that are configured to, when executed, cause the processor 708 to perform various functions disclosed herein, for example, with reference to FIG. 6. Alternatively, the computer-executable program 714 may not be directly executable by the processor 708 but may be configured to cause the node 700 (e.g., when compiled and executed) to perform various functions disclosed herein.

The processor 708 (e.g., having processing circuitry) may include an intelligent hardware device, a Central Processing Unit (CPU), a microcontroller, an ASIC, etc. The processor 708 may include memory. The processor 708 may process the data 712 and the computer-executable program 714 received from the memory 702, and information received via the transceiver 706, the baseband communications module, and/or the NW communications module. The processor 708 may also process information to be sent to the transceiver 706 for transmission through the antenna 710 to the NW communications module for subsequent transmission to a CN.

One or more presentation components 704 may present data to a person or other device. Examples of presentation components 704 may include a display device, speaker, printing component, vibrating component, etc.

From the present disclosure, it is manifested that various techniques may be used for implementing the disclosed concepts without departing from the scope of those concepts. Moreover, while the concepts have been disclosed with specific reference to certain implementations, a person of ordinary skill in the art would recognize that changes may be made in form and detail without departing from the scope of those concepts. As such, the disclosed implementations are to be considered in all respects as illustrative and not restrictive. It should also be understood that the present disclosure is not limited to the particular disclosed implementations. Many rearrangements, modifications, and substitutions are possible without departing from the scope of the present disclosure.

What is claimed is:

1. A method performed by a User Equipment (UE) for constructing a Hybrid-Automatic-Repeat-Request Acknowledge (HARQ-ACK) codebook, the method comprising:
receiving a Radio Resource Control (RRC) message from a Network (NW), the RRC message including an indication to the UE whether to disable a HARQ feedback for a HARQ process;
if the indication of the RRC message indicates to the UE to disable the HARQ feedback for the HARQ process, not generating a HARQ-ACK bit corresponding to a first Transport Block (TB) and generating at least one HARQ-ACK bit corresponding to at least one second TB; and
if a Downlink Control Information (DCI) format from the NW indicates to the UE to feedback reception of the first TB and the at least one second TB in a same slot, multiplexing the at least one HARQ-ACK bit to construct the HARQ-ACK codebook for the first TB and the at least one second TB.

2. The method of claim 1, wherein the indication of the RRC message configures a harq-ACK-Disabled-List parameter.

3. The method of claim 1, further comprising:
if the indication of the RRC message indicates to the UE to disable the HARQ feedback for the HARQ process, dropping at least one HARQ-ACK bit associated with the HARQ process that is disabled.

4. The method of claim 3, further comprising:
receiving a DCI message from the NW; and
if the one HARQ-ACK bit associated with a disabled HARQ process ID is dropped, ignoring a Downlink Assignment Index (DAI) field of the DCI message.

5. The method of claim 1, further comprising:
if a transmission for one TB is indicated with a Temporary Cell Radio Network Temporary Identifier (T-CRNTI) and a contention resolution corresponding to the transmission is not yet successful, or if the HARQ process associated with the transmission is indicated with a Message B-RNTI (MSGB-RNTI) and a Random Access (RA) procedure is not yet successfully completed, or if the HARQ process is equal to a broadcast process, or if a TimeAlignment timer associated with a tag, which includes a serving cell on which the HARQ feedback is to be transmitted, is expired or stopped, not generating the HARQ-ACK bit corresponding to the one TB.

6. The method of claim 1, wherein the HARQ-ACK codebook is a Type-2 HARQ-ACK codebook, and the NW is a Non-Terrestrial Network (NTN).

7. A User Equipment (UE) in a wireless communication system for constructing a Hybrid-Automatic-Repeat-Request Acknowledge (HARQ-ACK) codebook, the UE comprising:
a processor; and
a memory coupled to the processor, wherein the memory stores a computer-executable program that, when executed by the processor, causes the UE to:
receive a Radio Resource Control (RRC) message from a Network (NW), the RRC message including an indication to the UE whether to disable a HARQ feedback for a HARQ process;
if the indication of the RRC message indicates to the UE to disable the HARQ feedback for the HARQ process, not generate a HARQ-ACK bit corresponding to a first Transport Block (TB) and generate at least one HARQ-ACK bit corresponding to at least one second TB; and
if a Downlink Control Information (DCI) message from the NW is indicated indicates to the UE to feedback reception of the first TB and the at least one second TB in a same slot, multiplex the at least one HARQ-ACK bit to construct the HARQ-ACK codebook for the first TB and the at least one second TB.

8. The UE of claim 7, wherein the indication of the RRC message configures a harq-ACK-Disabled-List parameter.

9. The UE of claim 7, wherein the computer-executable program, when executed by the processor, further causes the UE to:
if the indication of the RRC message to the UE to disable the HARQ feedback for the HARQ process, drop at least one HARQ-ACK bit being associated with the HARQ process that is disabled.

10. The UE of claim 9, wherein the computer-executable program, when executed by the processor, further causes the UE to:
receive a DCI message from the NW; and
if the one HARQ-ACK bit associated with a disabled HARQ process ID is dropped, ignore a Downlink Assignment Index (DAI) field of the DCI message.

11. The UE of claim 7, wherein the computer-executable program, when executed by the processor, further causes the UE to:
if a transmission for one TB is indicated with a Temporary Cell Radio Network Temporary Identifier (T-CRNTI) and a contention resolution corresponding to the transmission is not yet successful, or if the HARQ process associated with the transmission is indicated with a Message B-RNTI (MSGB-RNTI) and a Random Access (RA) procedure is not yet successfully completed, or if the HARQ process is equal to a broadcast process, or if a TimeAlignment timer associated with a tag, which includes a serving cell on which the HARQ feedback is to be transmitted, is expired or stopped, not generate the HARQ-ACK bit corresponding to the one TB.

12. The UE of claim 7, wherein the HARQ-ACK codebook is a Type-2 HARQ-ACK codebook, and the NW is a Non-Terrestrial Network (NTN).
